(19) United States
(12) Patent Application Publication
(10) Pub. No.: US 2016/0245167 A1
(43) Pub. Date: Aug. 25, 2016

(54) ROTARY OSCILLATING INTERNAL COMBUSTION ENGINE

(71) Applicant: Shai BARKAN, Tel Aviv (IL)

(72) Inventor: Shai BARKAN, Tel Aviv (IL)

(21) Appl. No.: 14/517,947

(22) PCT Filed: Oct. 8, 2014
(86) PCT No.: PCT/IB2014/065141

§ 371 Date: Oct. 20, 2014

Related U.S. Application Data
(60) Provisional application No. 61/899,234, filed on Nov. 3, 2013.

(51) Int. Cl. F02B 61/06; F02P 13/00; F02B 55/02; F02B 53/12; F02B 55/08

(52) U.S. Cl. CPC F02B 61/06; F02B 53/12; F02B 55/08; F02B 55/02; F02P 13/00

(57) ABSTRACT

A rotary oscillating internal combustion engine including an engine housing, an external rotor assembly rotatably deployed within the engine housing, an internal rotor rotatably deployed within the external rotor assembly, a first lobed drive gear associated with the external rotor assembly so as to rotate at a same oscillating rotational speed as the external rotor assembly, a second lobed drive gear associated with the internal rotor so as to rotate at a same oscillating rotational speed as the internal rotor and a pair of driven gears rigidly connected together and to an output shaft so as to rotate at the same angular velocity, the pair of driven gears being driven by the first and second drive gears, the pair of driven gears being rigidly connected to an output shaft.

### FIELD AND BACKGROUND OF THE INVENTION

The present invention relates to rotary internal combustion engines and in particular, it concerns an oscillatory rotating internal combustion engine.

Oscillatory rotating engines, pumps and compressor are known in the art. Such devises employ a plurality of rotors with interleaved vanes rotating around a central shaft arrangement. By changing the relative angular velocity of the rotors an oscillatory movement is superimposed on their uniform rotation, thereby modifying the volume of energy chambers defined by each pair of adjacent vanes of the different rotors. Inlet and exhaust ports are provided at appropriate points such that expansion and contraction of the working chambers will provide induction, compression, expansion and exhaust strokes. The forces that alternately drive adjacent pistons apart or together are transformed through gear sets that drive the output shaft.

### SUMMARY OF THE INVENTION

The present invention is an oscillatory rotating internal combustion engine.

According to the teachings of the present invention there is provided, a rotary oscillating internal combustion engine comprising: (a) an engine housing; (b) an external rotor assembly rotatably deployed within the engine housing; and (c) an internal rotor rotatably deployed within the external rotor assembly; wherein at least one spark plug is deployed on the external rotor assembly so as to rotate wherewith.

According to the teachings of the present invention, the external rotor assembly includes power grooves formed in the outer circumferential surface of the external rotor assembly such that there is one the power groove for each the spark plug.

According to the teachings of the present invention, each the power grove includes a non-conductive liner and a conductive strip.

According to the teachings of the present invention, there is also provided at least one valve actuator deployed on the external rotor assembly so as to rotate wherewith.

There is also provided according to the teaching of the present invention, a rotary oscillating internal combustion engine comprising: (a) an engine housing/stator; (b) an external rotor assembly rotatably deployed within the engine housing; and (c) an internal rotor rotatably deployed within the external rotor assembly; wherein at least one valve actuator is deployed on the external rotor assembly so as to rotate wherewith.

According to the teachings of the present invention, the valve actuator includes an axle shaft that extends through sides plates of the external rotor assembly

According to the teachings of the present invention, there is also provided a valve having a bulbous valve stem tip that engages an elliptical valve control groove formed in the valve actuator such that as the valve actuator rotates the bulbous valve stem tip traverses a path of the elliptical valve control groove and in doing so, the valve is displaced between an open and a closed position.

According to the teachings of the present invention, there is also provided at least one spark plug deployed on the external rotor assembly so as to rotate wherewith.

There is also provided according to the teaching of the present invention, a gear set for use with a rotary oscillating device, the gear set comprising: (a) a first lobed drive gear associated with an external rotor assembly so as to rotate at a same oscillating rotational speed as the external rotor assembly; (b) a second lobed drive gear associated with an internal rotor so as to rotate at a same oscillating rotational speed as the internal rotor; and (c) a pair of driven gears rigidly connected together and to an output shaft so as to rotate at the same angular velocity, the pair of driven gears being driven by the first and second drive gears, the pair of driven gears being rigidly connected to an output shaft; wherein the first and the second drive gears and each one of the pair of driven gears all have the same size, shape and number of teeth.

According to the teachings of the present invention, each of the first and the second drive gears and each one of the pair of driven gears has at least one maximum point and at least one minimum point corresponding to at least one power stroke.

According to the teachings of the present invention, the at least one maximum point and at least one minimum point are configured as one of two, three, four, five and six maximum points and minimum points, corresponding to one of two, three, four, five and six power strokes per engine revolution respectively.

### BRIEF DESCRIPTION OF THE DRAWINGS

The invention is herein described, by way of example only, with reference to the accompanying drawings, wherein:

FIG. 1 is an exploded drawing of 2 stroke oscillatory rotating internal combustion engine constructed and operational according to the teaching of the present invention, shown here with a 4 vane inner rotor, 8 combustion chamber outer rotor, gear drive sets and induction and exhaust components;

FIG. 2 is a longitudinal cross section of the engine of FIG. 1;

FIG. 3 is a transverse cross section of the engine of FIG. 1;

FIG. 4 is an isometric view of the outer rotor and intake and exhaust discs the engine of FIG. 1;

FIG. 5 is a cross section of the outer rotor the engine of FIG. 1;

FIG. 6A is an isometric view of the outer rotor the engine of FIG. 1, here showing electrical contact strips on the outer edges;

FIG. 6B is a detail of FIG. 6A;

FIG. 7 is a transverse cross section of the outer rotor the engine of. FIG. 1;

FIG. 8 is an isometric cut-a-way view of an alternative valve arrangement, constructed and operational according to the teaching of the present invention, for use with a modified embodiment of the engine of FIG. 1;

FIGS. 9 and 10 are details of the alternative valve arrangement of FIG. 8;

FIG. 11-13 are isometric side views of two variations of drive configurations for the alternative valve arrangement of 8;

FIGS. 14A-19B are diagrams of work cycle of one possible embodiment of an oscillatory rotating internal combustion engine constructed and operational according to the teaching of the present invention, illustrated here with a single vane inner rotor, twin combustion chamber outer rotor, producing two power strokes per shaft revolution and corresponding drive and driven gear pairs' rotation;

FIG. 20 is a drawing of eccentric elliptical gear geometry for an engine having one power stroke per revolution;

FIG. 21 is a drawing of concentric elliptical gear set geometry for an engine having two power strokes per revolution;

FIG. 22 is a drawing of concentric three lobe gear set geometry for an engine having three power strokes per revolution;

FIG. 23 is a drawing of concentric four lobe gear set geometry for an engine having four power strokes per revolution;

FIG. 24 is a drawing of concentric five lobe gear set geometry for an engine having five power strokes per revolution; and

FIG. 25 is a drawing of concentric six lobe gear set geometry for an engine having six power strokes per revolution.

### DESCRIPTION OF THE PREFERRED EMBODIMENTS

The present invention is an oscillatory rotating internal combustion engine.

The principles and operation of an oscillatory rotating internal combustion engine according to the present invention may be better understood with reference to the drawings and the accompanying description.

By way of introduction, a principal object of the invention is to provide a rotary piston apparatus employing two concentric rotating members and a centrally located, eccentrically mounted, coupling means between the two members to create compression and/or expansion power strokes for applications to pumps, compressors and internal combustion engines.

The oscillatory rotating internal combustion engine of the present invention provides one or more combustion chambers per rotor for varying possible power output.

It should be noted that the oscillatory rotating internal combustion engine of the present invention may be configured as either a 2 stroke or 4 stroke engine.

The oscillatory rotating internal combustion engine of the present invention also provides two pairs of elliptical and eccentrically rotating gears for maintaining a varying rotational speed ratio between the two rotating rotors and produce continuous rotational speed of power transmission trough a common output shaft.

The design of the oscillatory rotating internal combustion engine of the present invention further provides minimal acceleration and deceleration of said rotors, relative to engine case, so as to reduce vibration and force loads on the engine or pump.

The oscillatory rotating internal combustion engine of the present invention may be configured so as to perform a variety of the number of work cycles per output shaft revolution.

The oscillatory rotating engine of the present invention employs a circular housing in which, a pair of rotors with a plurality of interleaved vanes, revolves around the center of rotation. By changing the angular velocity of the rotors an oscillatory movement is introduced into their uniform rotation, thus modifying the volume of combustion chambers defined by one face a vane and the corresponding inner surface of the outer rotor. Inlet and exhaust are provided at appropriate points on side faces of outer rotor, while spark plugs deployed on the circumferential outer wall of the outer rotor, so that expansion and contraction of the working chambers will provide induction, compression, power and exhaust strokes. Oscillating power pulses produced are transformed to continuous power flow that drives the output shaft by means of two pairs of lobed gear sets of various possible shapes. Each pair of lobed gears has the same size, shape and number of teeth. Driven gears are rigidly connected together and rotate at the same angular velocity. Drive gears are rigidly connected to inner and outer rotors and rotate with said rotors. Relations and shapes of drive gear sets are directly related to number of combustion chambers and number of power strokes per rotors revolution.

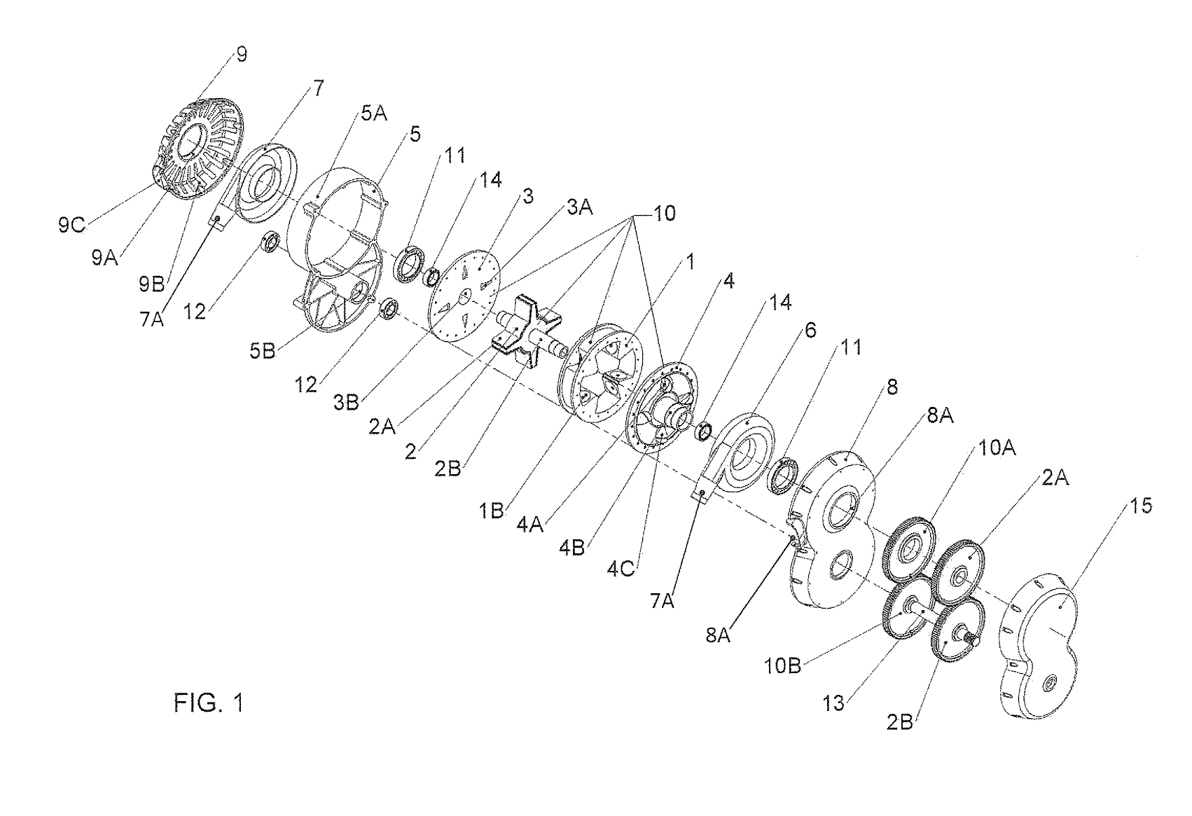

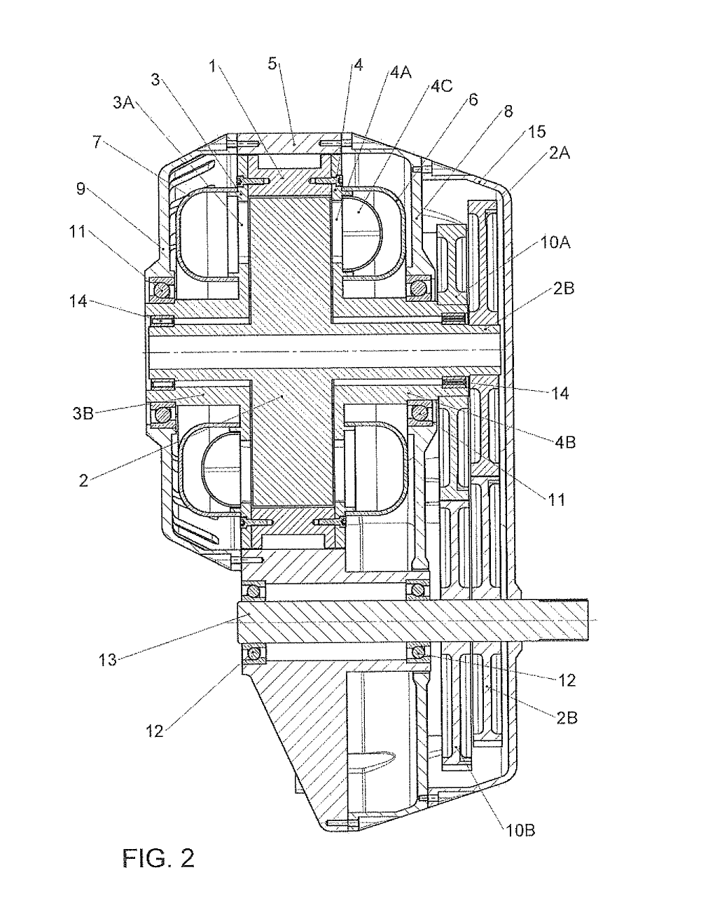

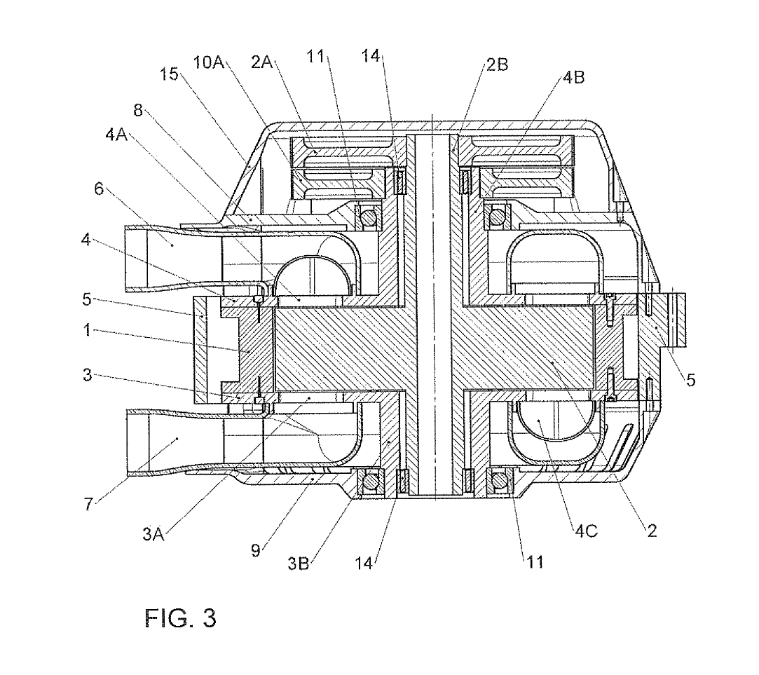

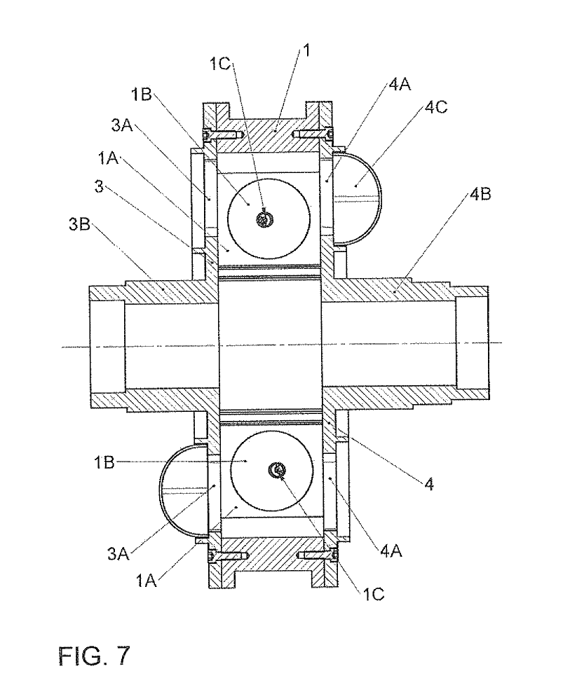

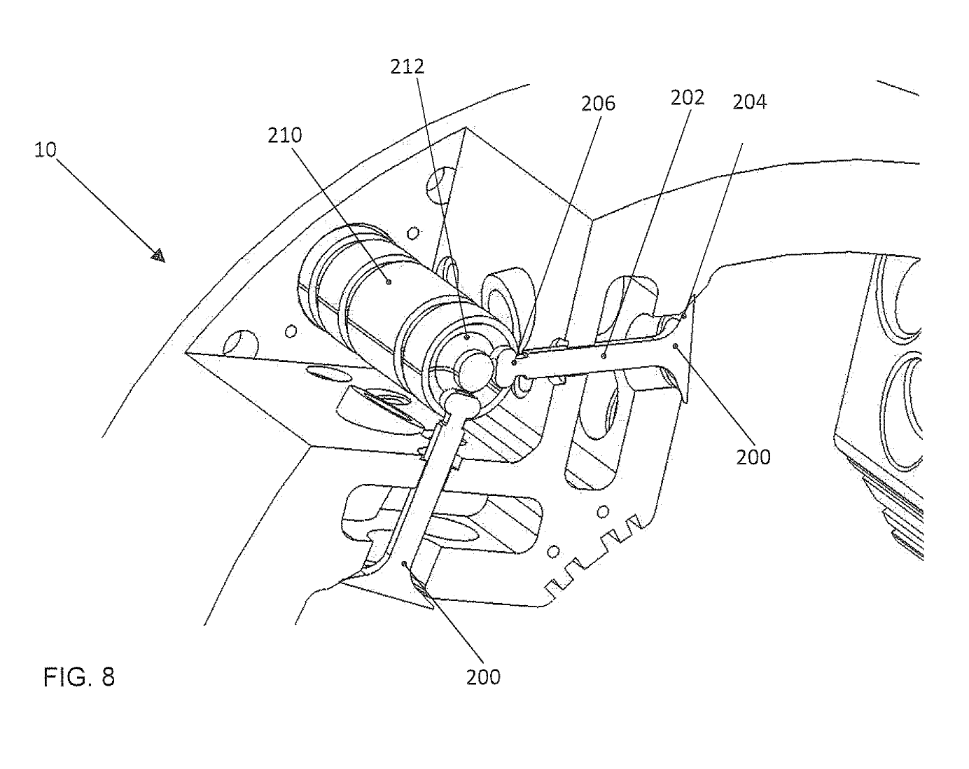

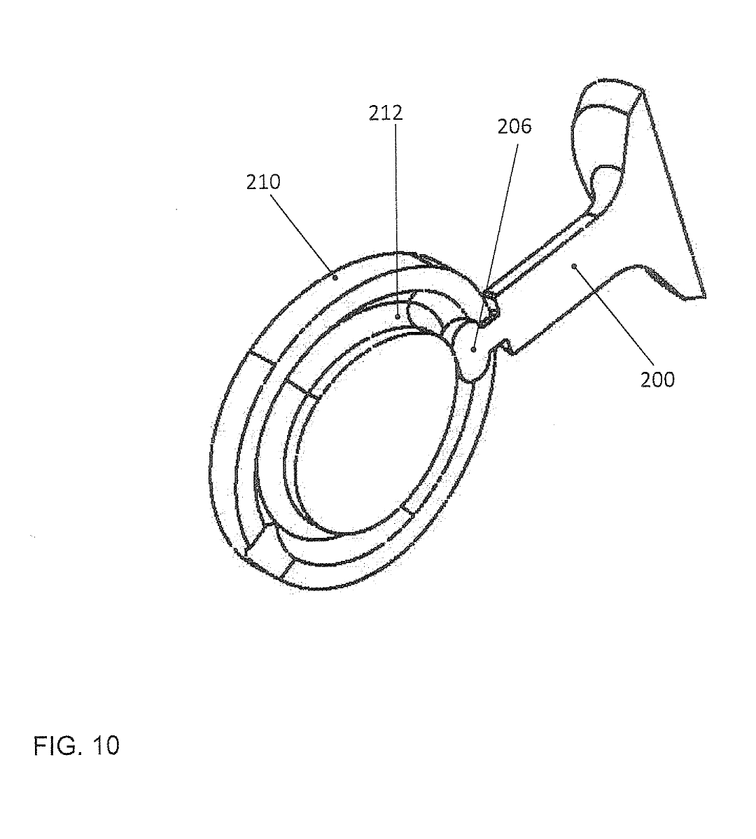

Referring now to the drawings, FIGS. 1-10 illustrate the structure of a preferred embodiment of the oscillatory rotating internal combustion engine of the present invention. An external rotor assembly 10 and internal rotor 2 are rotatably mounted in engine housing 5

External rotor assembly 10 is rigidly attached to external rotor drive gear 10A and internal rotor 2 is rigidly attached to internal rotor drive gear 2A. Two driven gears, 108 and 2B are rigidly attached to output shaft 13 which is rotatably mounted in engine housing 5, parallel to rotors 1 and 2 and rotates opposite to said rotors direction of rotation.

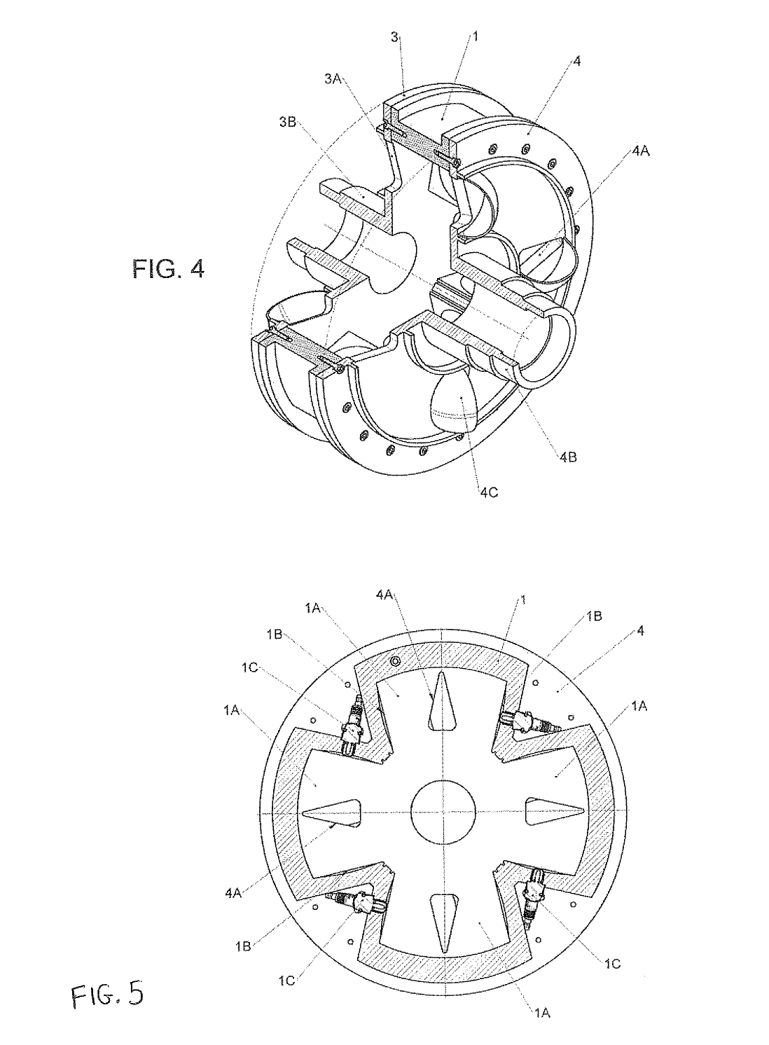

FIGS. 4-7 show the external rotor assembly 10 comprising external rotor 1, intake disc 4, incorporating a circular plate with intake ports 4A and concentric hollow cylindrical protrusion 48, exhaust disc 3, incorporating a circular plate with exhaust ports 3A and concentric hollow cylindrical protrusion 3B. Exhaust disc 3 and intake disc 4 are concentrically and rigidly attached to respective side faces of external rotor 1. Cylindrical shaped protrusions 3B and 4B are axially aligned and form external rotor 1 axis of rotation.

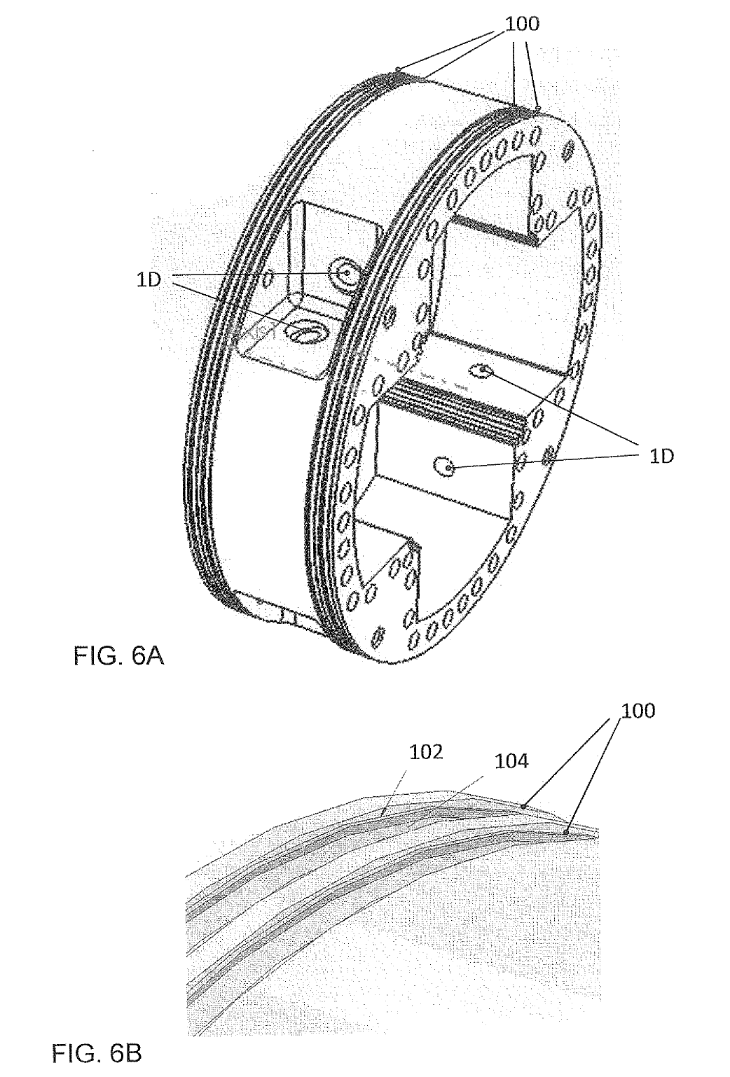

External rotor 1, as best illustrated in FIG. 5, is substantially ring shaped with plurality of radially arranged cutouts 1A forming the equivalent of reciprocating engine cylinders. Concave depressions 1B on radial faces of cutouts 1A form the engine combustion chambers with sparkplugs 1C mounted in threaded bores 1D (best seen in FIG. 6A).

It will be readily appreciated that one unique feature of the present invention is that the spark plugs 1C are mounted on, and rotate with, the external rotor assembly 10. In order to provide the necessary electrical connection to the rotating spark plugs 1C, power grooves 100 are formed in the outer circumferential surface of the external rotor assembly 10 such that there is one power groove 100 for each spark plug 1C. As best illustrated in FIG. 6B, each power grove 100 includes a non-conductive liner 102 and a conductive strip 104. It will be understood the corresponding brushes are configured on the inner surface of the stator segment 5A of engine housing 5 and that conventional style spark plug wires may be employed to connect each of the power grooves 100 to a corresponding spark plug. It will be appreciated that the number of spark plugs 1C and therefore the number of power grooves 100 may be varied according to the design requirements of a particular engine application.

Internal rotor 2 includes a cylindrical center portion with at least one radial protrusion 2A, serving as piston, and an axial protruding shaft 2B which rotates inside protrusions 3B and 4B of external rotor assembly 10.

Exhaust side cover 9 is a circular, dish shaped cover, incorporating bearing housing 9A, cooling slots 9B and exhaust manifold opening 9C. The exhaust cover 9 is concentrically and rigidly attached to the exhaust side face of engine housing 5.

Intake side cover 8 is double circular shaped cover, incorporating bearing housing 8A and intake manifold opening 8B. The intake cover 8 is concentrically and rigidly attached to intake side face of engine housing 5.

External rotor assembly 10 rotates in bearings 11 mounted in bearing housings 9A and 8A.

Engine housing 5 includes a ring shaped stator segment 5A, in which the external rotor assembly 10 and the internal rotor 2 rotate, and disc shaped element having round tube 5B and bearing housings 5C, for bearings 12, in which output shaft 13 rotates.

Intake manifold 6 includes a longitudinal sliced toroidal shaped ring and tangentially connected intake pipe 6A. The intake manifold 6 is rigidly and concentrically attached to intake cover 8.

Exhaust manifold 7 comprises a longitudinally sliced toroidal shaped ring and tangentially connected exhaust pipe 7A. The exhaust manifold is rigidly and concentrically attached to exhaust cover 9.

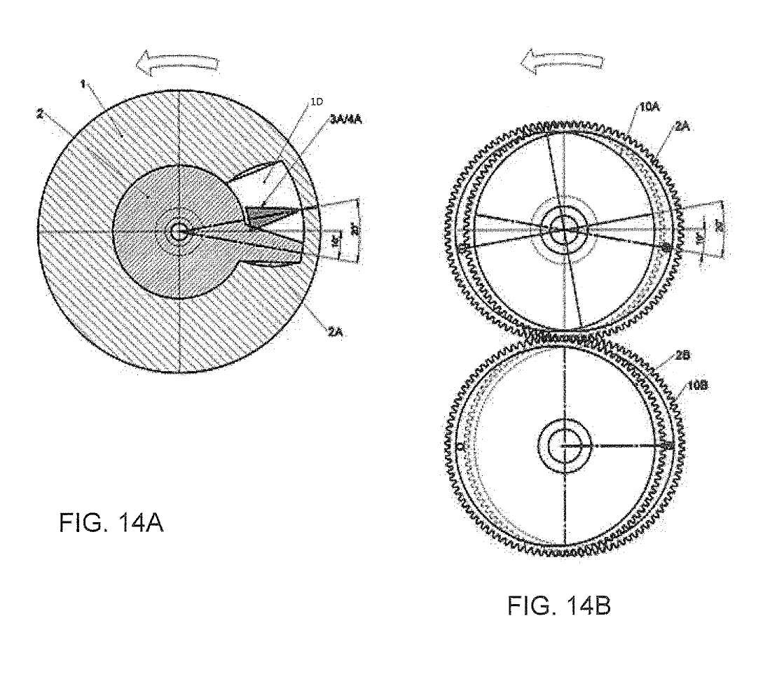

FIGS. 14A-19B illustrate the engine phase cycle of the preferred embodiment of a two stroke work cycle of the oscillatory rotating internal combustion engine of the present invention. The drawings refer to a one vane 2A internal rotor 2 and one chamber 1A external rotor 1 with work cycles alternating in both sides of internal rotor vane 2A, producing one work phase per internal rotor vane side, per rotors revolution. Intake and exhaust ports 4A and 3A respectively are at opposite sides of rotor 1 and are shown superimposed. The number of internal rotor vanes and power chambers can be increased to any desirable and practical number.

FIG. 14A shows the relative position of the external rotor assembly 10 and the internal rotor 2 in which internal rotor vane 2A is in Top Dead Center (TDC) for combustion chamber 1D and at Bottom Dead Center (BDC) for combustion chamber 1E. Air fuel mixture is drawn to chamber 1E through port 4A. At this stage a spark is introduced in chamber 1D and work phase starts.

Corresponding drive gear positions are illustrated in FIGS. 14B, 15B, 16B, 17B, 18B and 19B.

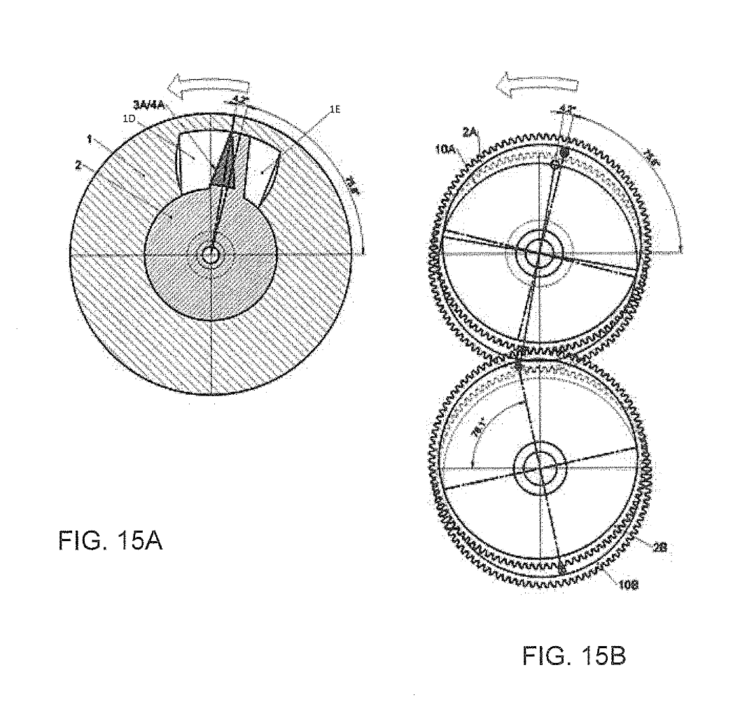

FIG. 15A shows chamber 1D in work phase and chamber 1E at the end of the intake and exhaust phases where intake and exhaust ports 3A, 4A are closed by internal rotor vane 2A. It should be noted that at this stage internal rotor 2 rotates faster than external rotor 1, thus producing power/compression strokes at opposite sides of vane 2A.

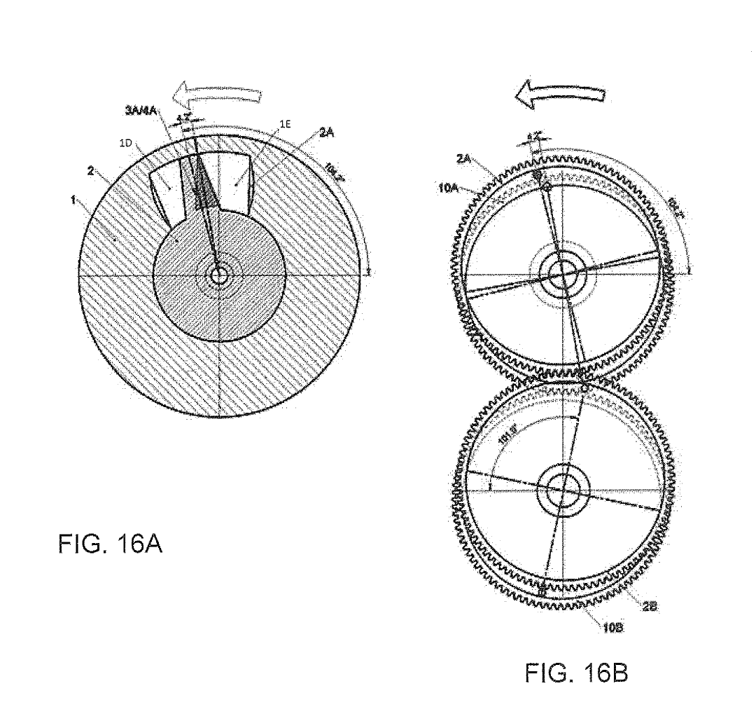

FIG. 16A shows combustion chamber 1D at end of power stroke and chamber 1E during compression stage, prior to ports 3A, 4A being exposed by vane 2A.

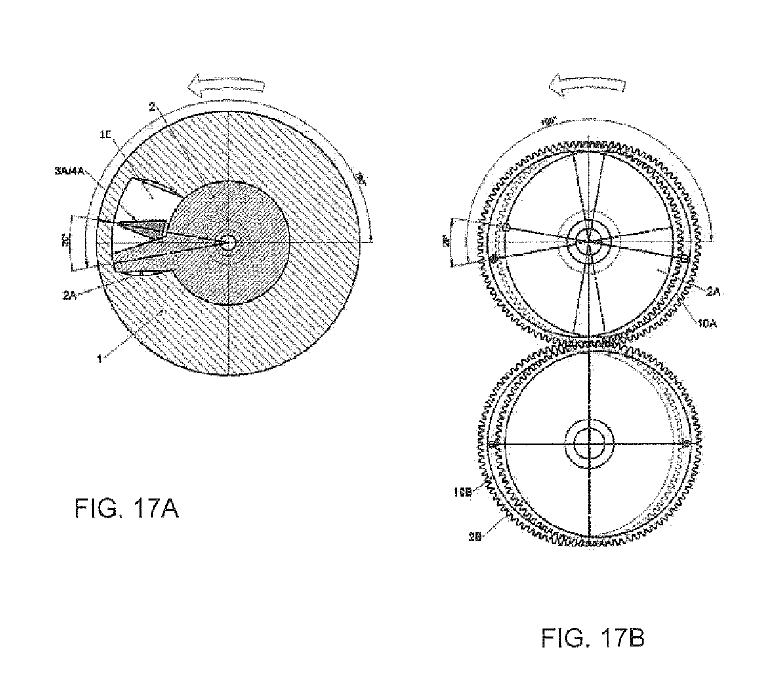

FIG. 17A shows the relative position of the external rotor assembly 10 and the internal rotor 2 where internal rotor vane 2A is in Top Dead Center (TDC) for combustion chamber 1E and at Bottom Dead Center (BDC) for combustion chamber 1D. Air fuel mixture is drawn to chamber 1D through port 4A and burnt gases expelled through opposite exhaust port 3A. At this stage a spark is introduced in chamber 1E and a work phase starts. At this point the relative rotational speed of the external rotor assembly 10 and the internal rotor 2 alternates due to gear set geometry and internal rotor 2 rotates slower than external rotor 1, thus reversing power/compression strokes at opposite sides of vane 2A.

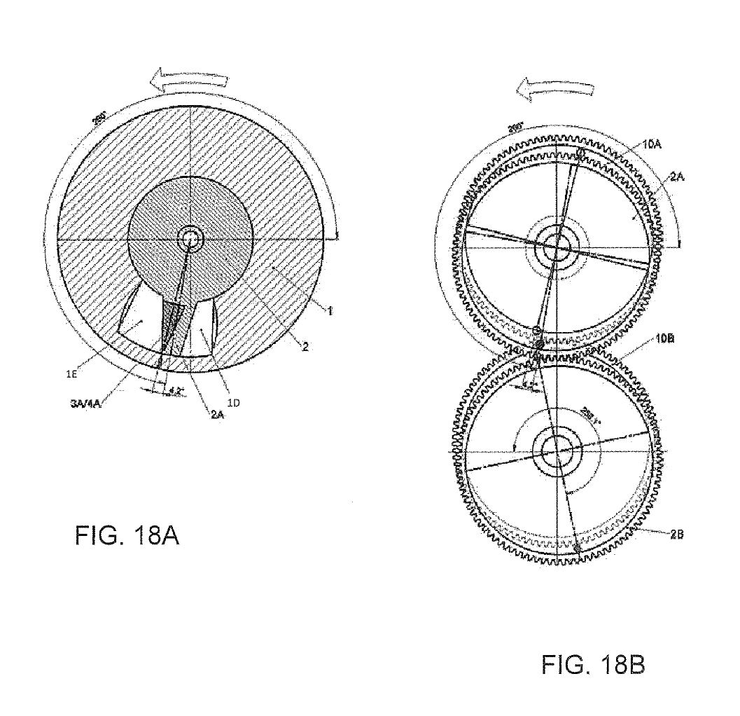

FIG. 18A shows chamber 1E in work phase and chamber 1D at end of intake and exhaust phases where intake and exhaust ports 3A 4A are closed by internal rotor vane 2A.

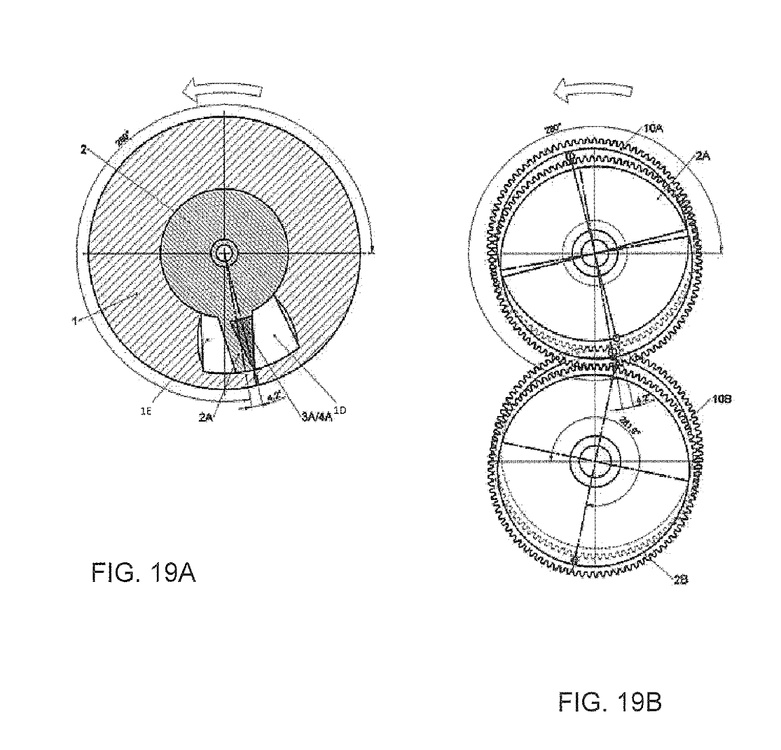

FIG. 19A shows combustion chamber 1E at end of power stroke and chamber 1D during compression stage, prior to ports 3A, 4A being exposed by vane 2A. After completion of this stage, rotors 1 and 2 have completed one revolution comprising one power stroke for each side of internal rotor vane 2A. Drive gears 10A and 2A, which rotate at alternating speeds, also complete one revolution and transmit alternating power pulses to gears 28 and 10B, which rotate at constant speed.

It will be understood that during the above described work cycle, compressed air and fuel mixture is fed to inlet ports 4A through intake manifold 6 which is stationary but fits closely to intake plate 4. Scoops 4C, located in intake plate 4, aid in directing air fuel mixture to inlet ports 4A. Burnt gases are expelled through exhaust manifold 7, aided by centrifugal effect produced by scoops 3B placed on exhaust plate 3.

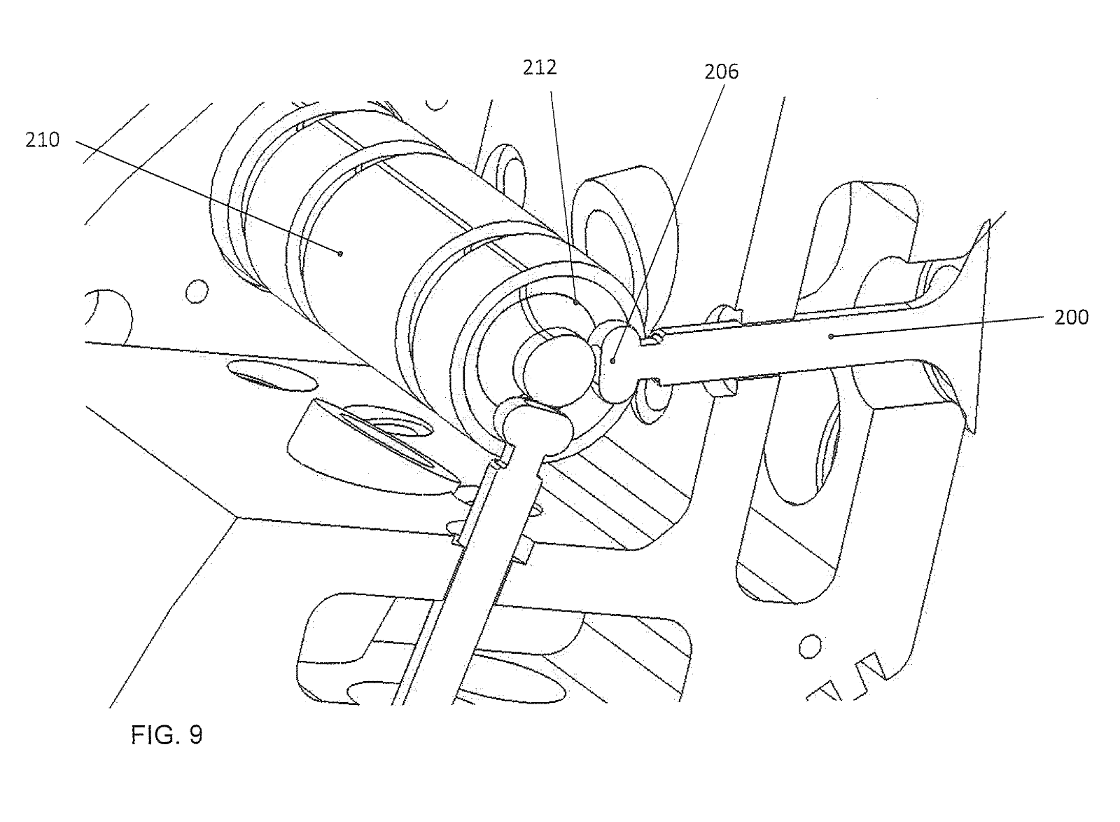

Referring back to FIGS. 8-13, which illustrate an alternative valve configuration for use in a four stoke embodiment of the oscillatory rotating engine of the present invention. As illustrated here, intake port 3A and exhaust port 4A are replaced with more conventional four stoke valve 200 having a valve stem 202 that extends such that the valve seat 204 closes an opening in the concave depression 1B on radial faces of cutouts 1A of the engine combustion chambers and a bulbous valve stem tip 206.

The valves 200 are operated between an open and closed position by a valve actuator 210 that is rotatably mounted on the external rotor assembly 10. It will be understood that the valve actuator 210 includes an axle shaft (now shown) that extends through the exhaust plate 3 and the intake plate 4 which form the side plates of the external rotor assembly 10.

It will be readily recognized that this valve assembly does not include valve lifters as is the current industry standard. The bulbous valve stem tip 206 of valve stem 202 engages the modified-elliptical valve control groove 212 of the valve actuator 210 such that as valve actuator 210 rotates bulbous valve stein tip 206 traverses the path of the modified-elliptical valve control groove 212. In doing so, valve 200 is displaced between an open and a closed position in a substantially continuous reciprocating motion while the oscillatory rotating engine of the present invention is running. That is to say, the valve 200 is pushed and pulled by the valve actuator 210. It will be appreciated that the illustration of a modified-elliptical valve control groove is used here only as a non-limiting example and that the valve control groove may be configured with substantially any contour dependent on the valve displacement requirements of a particular design embodiment of an oscillatory rotating internal combustion engine of the present invention. It should be noted that, although not illustrated here, the use of a spring mechanism to force the valve 200 toward a closed position so as to enhance the sealing of the valve seat 204 for better performance of oscillatory rotating internal combustion engine of the present invention.

It will be readily appreciated that valve actuator 210 may be configured with substantially any number of elliptical valve control grooves so as to operate an appropriate number of valves as require by a particular engine design.

In its simplest embodiment, rotation of the valve actuator 210 is achieved by the interaction of a first gear rigidly attached to at least one end of the axle shaft of valve actuator 210 and a stationary second gear attached to the stator segment 5A of engine housing 5.

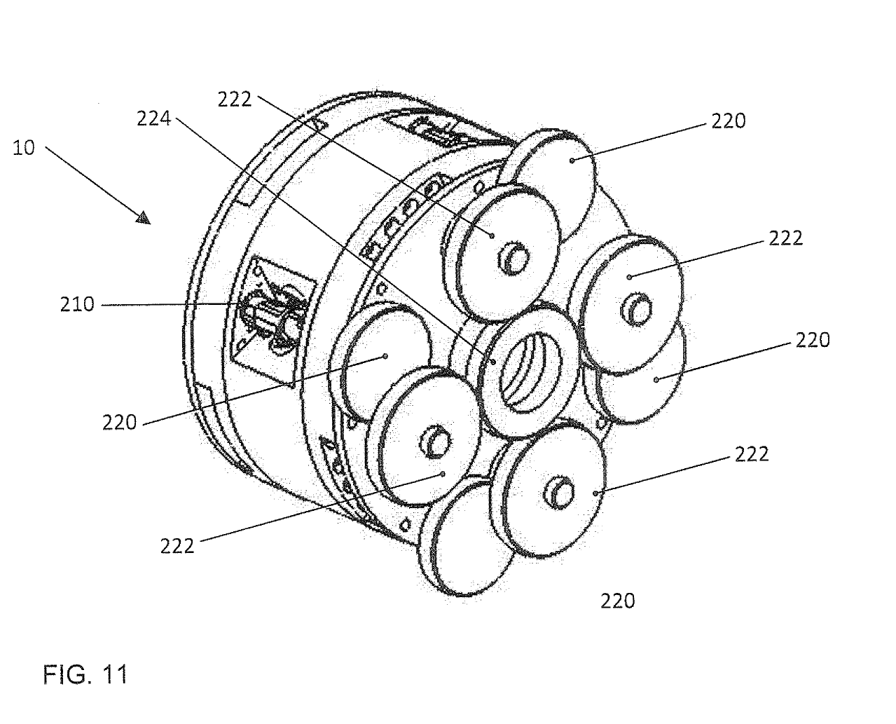

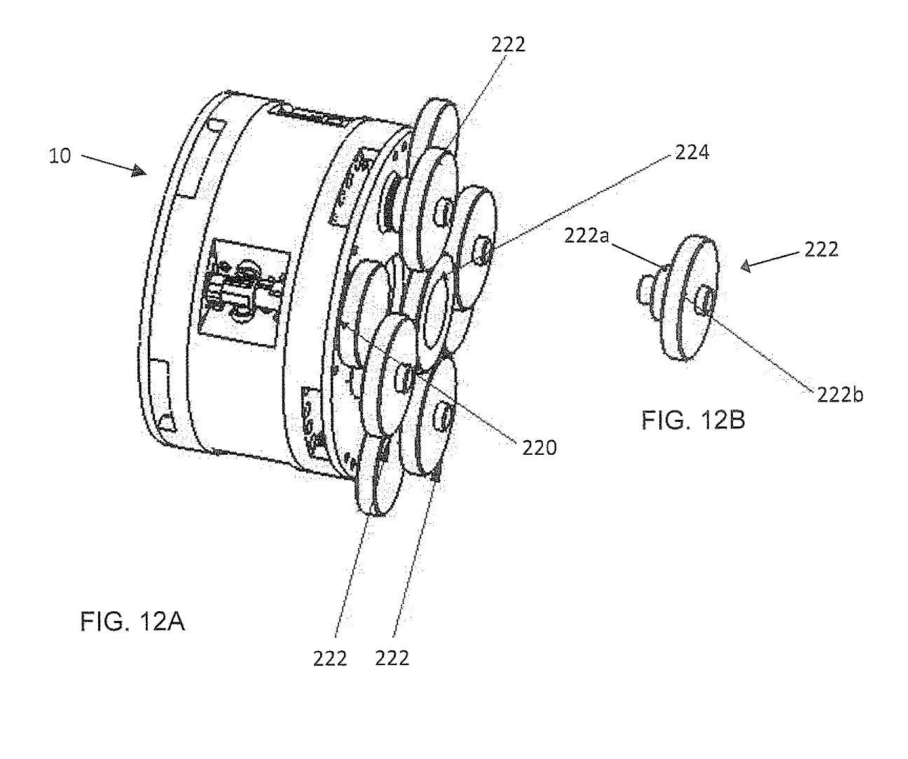

As illustrated in FIGS. 11-12B, rotation of the valve actuator 210 is achieved by the interaction of a plurality of gears, a set of four first gears 220 rigidly attached to the end of the axle shaft of valve actuator 210, a set of four intermediate rotation speed adjusting gears 222 and a stationary drive gear 224 attached to the stator segment 5A of engine housing 5. It will be appreciated that intermediate rotation speed adjusting gear 222 is configured so as to interact with first gear 220 via a first gear face 222a and with stationary drive gear 224 via a second gear face 222b. The ratio of the change of rotation speed is determined by the ratio of the size and/or number of teeth between the first gear face 222a and the second gear face 222b. Such a drive arrangement will be readily understood by one of skill in the art.

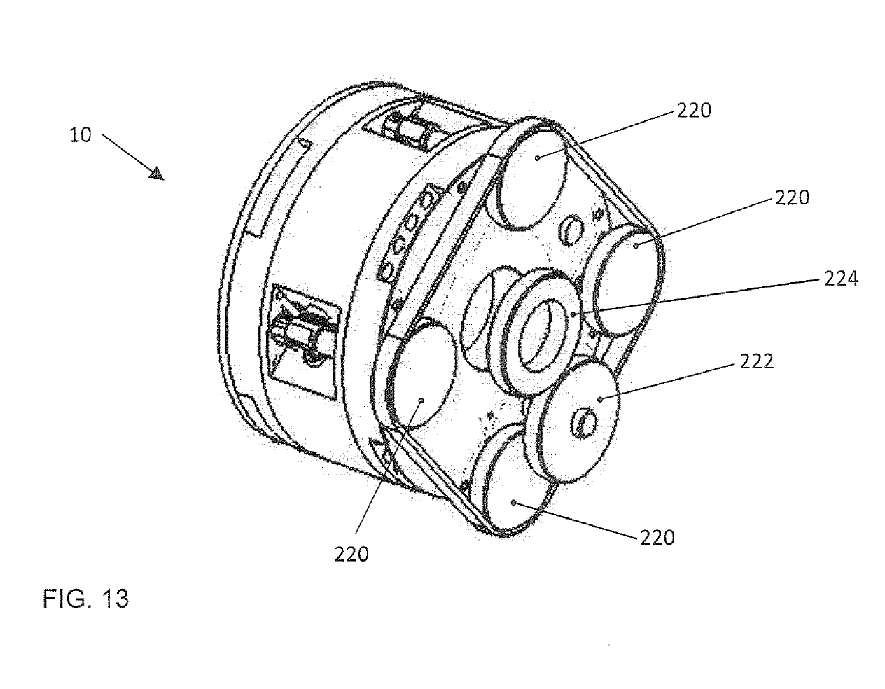

Alternatively, as illustrated in FIG. 13 rotation of the valve actuator 210 is achieved by the interaction of a stationary drive gear 224 attached to the stator segment 5A of engine housing 5, a single intermediate rotation speed adjusting gear 222, a set of four first gears 220 rigidly attached to the end of the axle shaft of valve actuator 210 one of which (210a) is operationally rotated via the single intermediate rotation speed adjusting gear 222 and the rotation is transferred to the other first gears 220 via a drive belt 228. It will be appreciated that drive belt 228 may alternatively be implemented as a drive chain. Here too, such a drive arrangement will be readily understood by one of skill in the art.

Attention is now directed toward the drive linkage of the oscillatory rotating engine of the present invention. The rotary oscillating engine drive linkage has two roles:

A. Transmit and combine external and internal rotors oscillating, pulsing revolutions into a continuous and smooth rotation at the output shaft.

B. Govern acceleration and deceleration rates of said rotors while maintaining a continuous rotation without stops or reverse rotation, therefore reducing loads on engine components and smoothing out power output.

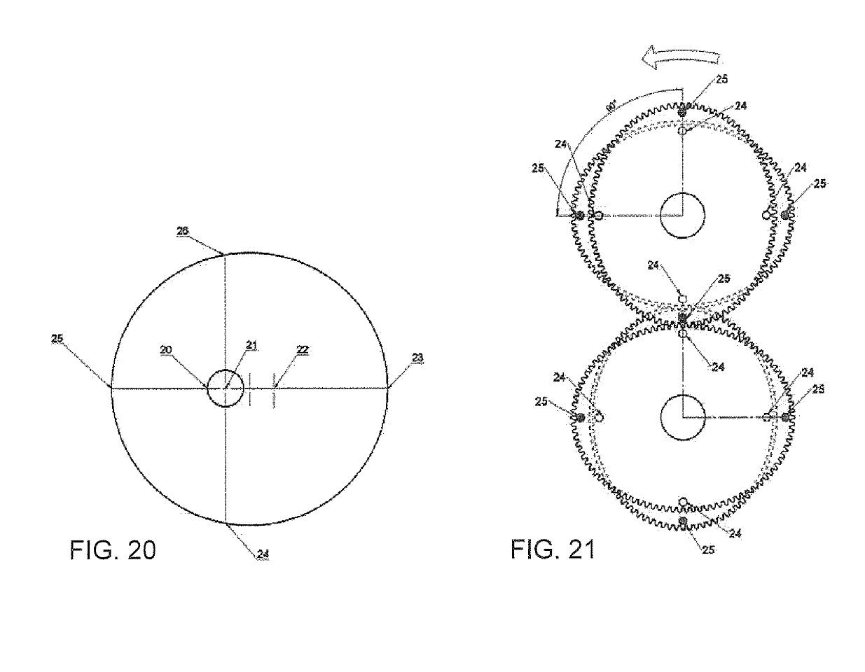

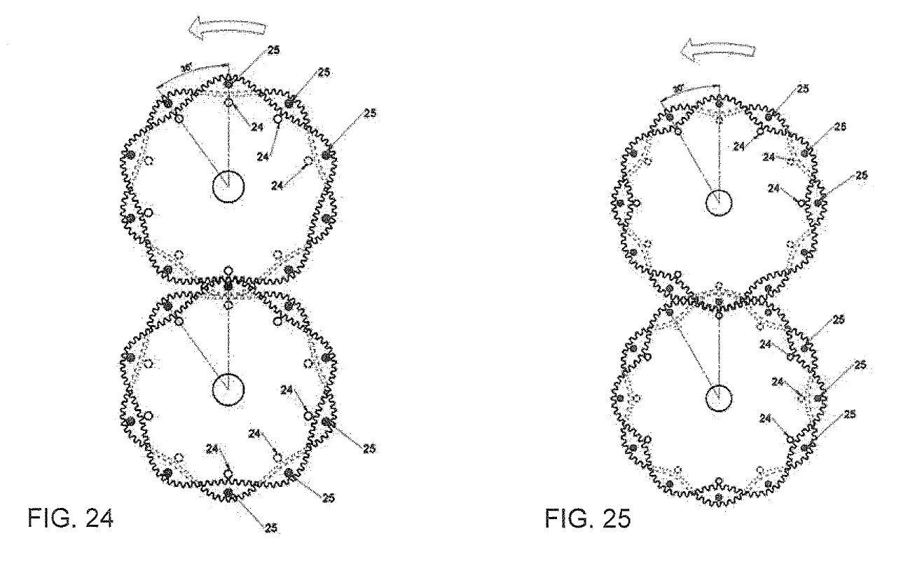

Generally speaking, drive gears 10A and 2A and driven gears 10B and 20 are identical in size, shape and number of teeth and therefore complete one revolution simultaneously. It will be appreciated that the gear shape is directly related to number of engine power pulses per output shaft revolution. With that in mind, attention is directed to specific examples as illustrated in FIGS. 20-25.

FIG. 20 illustrates elliptical shaped gears with center of rotation offset to ellipse geometrical focus 20; said gear has one maximum point 23 and one minimum point 25 and thus produces one power pulse per rotors revolution. Size proportion between 20-23 and 20-25 determine the length of power stroke. Driven gears 100 and 2B are rigidly attached to output shaft 13 at an angle of 180 degrees relative to each other thereby translating the variable relative speed between drive gears 10A and 2A, which are generated by the power and exhaust strokes of external rotor 10 and internal rotor 2, into the constant rotational speed of output shaft 13. It will be appreciated that the term “maximum point” is used herein to refer to a point of the circumference of the gear that is at the maximum distance from the center point of the gear. Likewise, the term “minimum point” is used herein to refer to a point of the circumference of the gear that is at the minimum distance from the center point of the gear.

FIG. 21 depicts elliptical gears with center of rotation at center of ellipse and driven gears fixed at 90 degrees relative to each other. This setup provides gears with two maximum points 25 and two minimum points 26, thus producing two power strokes per rotors revolution.

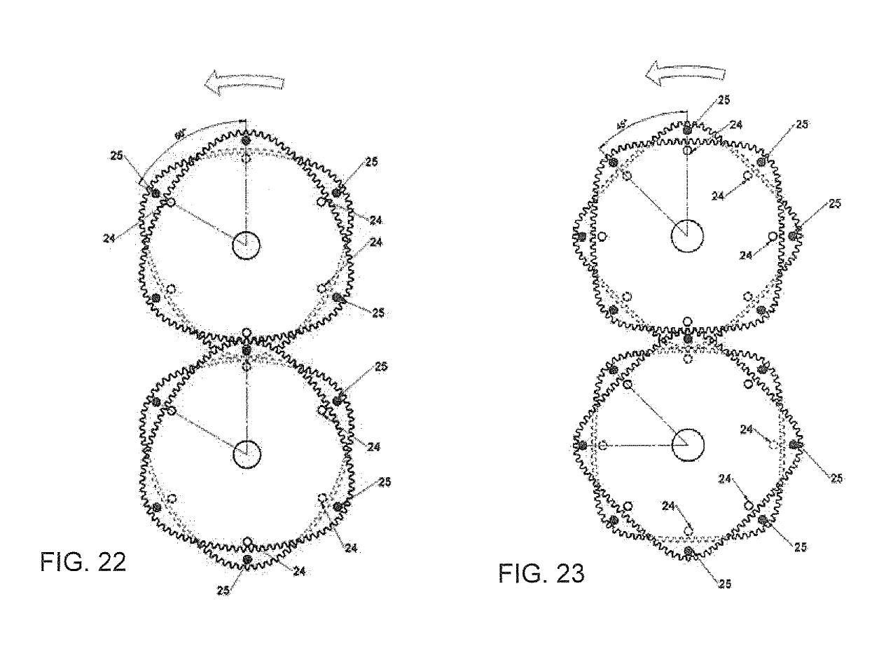

FIGS. 22-25 illustrate drive gears sets with three, four, five and six maximum points 25 and minimum points 26, providing three, four, five and six power strokes per rotors revolution respectively. The number of extremity points can be increased to any practical number in order to increase the number of power strokes per rotors revolution. Relative fixed angle between driven gears proportionally decreases with increase in gears number of maxima and minima points. Relative length difference between radial distances of extremity points in each gear set determines piston stroke angular distance and thus displacement.

It will be appreciated that the above descriptions are intended only to serve as examples and that many other embodiments are possible within the spirit and the scope of the present invention.

What is claimed is:

1. (canceled)

2. A rotary oscillating internal combustion engine comprising:
(a) an engine housing;
(b) an external rotor assembly rotatably deployed within said engine housing; and
(c) an internal rotor rotatably deployed within said external rotor assembly;
wherein at least one spark plug is deployed on said external rotor assembly so as to rotate wherewith.

3. The rotary oscillating internal combustion engine of claim 2, wherein said external rotor assembly includes power grooves formed in the outer circumferential surface of said external rotor assembly such that there is one said power groove for each said spark plug.

4. The rotary oscillating internal combustion engine of claim 3, wherein each said power grove includes a non-conductive liner and a conductive strip.

5. The rotary oscillating internal combustion engine of claim 2, further including at least one valve actuator deployed on said external rotor assembly so as to rotate wherewith.

6. A rotary oscillating internal combustion engine comprising:
(d) an engine housing/stator;
(e) an external rotor assembly rotatably deployed within said engine housing; and
(f) an internal rotor rotatably deployed within said external rotor assembly;
wherein at least one valve actuator is deployed on said external rotor assembly so as to rotate wherewith.

7. The rotary oscillating internal combustion engine of claim 6, wherein said valve actuator includes an axle shaft that extends through sides plates of said external rotor assembly

8. The rotary oscillating internal combustion engine of claim 6, further including a valve having a bulbous valve stem tip that engages an elliptical valve control groove formed in said valve actuator such that as said valve actuator rotates said bulbous valve stem tip traverses a path of said elliptical valve control groove and in doing so, said valve is displaced between an open and a closed position.

9. The rotary oscillating internal combustion engine of claim 6, further including at least one spark plug deployed on said external rotor assembly so as to rotate wherewith.

10. A gear set for use with a rotary oscillating device, the gear set comprising:
(a) a first lobed drive gear associated with an external rotor assembly so as to rotate at a same oscillating rotational speed as said external rotor assembly;
(b) a second lobed drive gear associated with an internal rotor so as to rotate at a same oscillating rotational speed as said internal rotor; and
(c) a pair of driven gears rigidly connected together and to an output shaft so as to rotate at the same angular velocity, said pair of driven gears being driven by said first and second drive gears, said pair of driven gears being rigidly connected to an output shaft;
wherein said first and said second drive gears and each one of said pair of driven gears all have the same size, shape and number of teeth.

11. The gear set of claim 10, wherein each of said first and said second drive gears and each one of said pair of driven gears has at least one maximum point and at least one minimum point corresponding to at least one power stroke.

12. The gear set of claim 11, wherein said at least one maximum point and at least one minimum point are configured as one of two, three, four, five and six maximum points and minimum points, corresponding to one of two, three, four, five and six power strokes per engine revolution respectively.
